(19) United States
(12) Patent Application Publication
(10) Pub. No.: US 2019/0180387 A1
(43) Pub. Date: Jun. 13, 2019

(54) ONLINE PLATFORM FOR CREATING CONNECTIONS BETWEEN TWO USERS AS A FUNCTION OF OPINIONS ON ISSUES.

(71) Applicant: EPISTOCRACY, LLC, Melville, NY (US)

(72) Inventor: Brandon SIEGENFELD, Melville, NY (US)

(21) Appl. No.: 15/999,614

(22) PCT Filed: Feb. 17, 2017
(86) PCT No.: PCT/US17/18396

§ 371 Date: Aug. 20, 2018

Related U.S. Application Data
(60) Provisional application No. 62/296,788, filed on Feb. 18, 2016.

(51) Int. Cl. G06Q 50/00; G06Q 30/02; H04L 12/58

(52) U.S. Cl. CPC G06Q 50/01; H04L 51/32; G06Q 30/0201

(57) ABSTRACT

A platform and a method for identifying the support for a single stances put forth by a source. In one non-limiting example, the stances can be a stance on a political issue from a candidate or a supporter of a candidate. The online platform creates connections between two users as a function of shared opinions on an issue and dissolves connections between two users when an opinion on that issue is not shared. The online networking platform determines a leader for a stances on an issue. The platform determines one or more supporters for that issue and links each supporter to the leader as a function of support for that particular issue. In a preferred non-limiting embodiment, a supporter may only select one leader for each issue, in this way ensuring that the supporter adopts the stances of the leader for that particular issue to maintain the connection.

### CROSS REFERENCE TO RELATED APPLICATION

This application claims the benefit of U.S. Provisional Patent Application No. 62/296,788, filed Feb. 18, 2016, the contents of which are herein incorporated.

### BACKGROUND THE INVENTION

An online network that allows for a connection to be formed between two users in which one user has some ability that the other forming the connection does not; the one who formed the connection has the ability to terminate the connection. The online networking platform allows for the creation of a connection between two or more users on each specific issue, one user acting as a leader and the second user as a supporter. A supporter can only have one leader per issue because the supporter must adopt the stances of that leader for that particular issue to maintain the connection. The system tracks and connects one user to a leader.

Currently, social media is flooded with messages regarding stances on issues, particularly political issues. This is particularly true during times of intense political debate such as during the two or more years leading up to an election cycle. In order to determine whether a person proposing a stance on an issue has a following, they must either create a web page and invite subscribers, or publish a blog with the ability to comment. However, it is riot possible to ascertain the amount of support any one single stances of the publisher has. The blog contains both pro and con, as well as nuances of differences with the stances, even when supporting the stances. Similarly, subscribers to a webpage, cannot be certified as being supporters of any one particular stances.

Accordingly, a system and method for aligning users in support of a stances and monitoring the strength of that support for the leader or proposer of the stances is desired.

### SUMMARY OF THE INVENTION

This invention defines a platform and a method for identifying the support for a single stances put forth by a user. In one non-limiting example, the stances can be a stance on a political issue from a candidate or a supporter of a candidate. The online platform of the current invention creates connections between two users as a function of shared opinions on an issue and dissolves connections between two users when an opinion on that issue is not shared. The online networking platform determines a leader for a stances on an issue. The platform determines one or more supporters for that issue and links each supporter to the leader as a function of support for that particular issue. In a preferred non-limiting embodiment, a supporter may only select one leader for each issue, in this way ensuring that the supporter adopts the stances of the leader for that particular issue to maintain the connection.

### BRIEF DESCRIPTION OF THE DRAWINGS

The present disclosure is better understood reading the written description with reference to the accompanying drawings in which the reference numerals denote the similar structures and refer to the elements throughout, in which:

FIGS. 1A, 1B are a flow chart for displaying the steps for creating a support connection in accordance with the invention;

FIGS. 2A, 2B are a flow chart showing the process for changing a stance after a stance has obtained supporters for a user;

FIGS. 3A-3D is a representation of a sample network in accordance with the invention showing the creation and the dissolution of connections over time for the exemplary issue of a carbon tax;

FIG. 4 is a flow chart showing confirmation of support in a stance in accordance with the invention;

FIG. 5 is an operational diagram of a database profile in accordance with the invention;

FIG. 6 is a screen shot of a webpage containing the political stances of a user presented in accordance with the invention;

FIG. 7 is a screen shot of a webpage for editing a stance in accordance with the invention;

FIG. 8 is a screen shot of a webpage enabling a user to break support for a stance and leader in accordance with the invention;

FIG. 9 is a screen shot of a webpage sent by the platform to a supporter of a change in stance by a leader on a stance being supported by the user;

FIG. 10 is a screen shot of a webpage in which the platform enables a user to accept the stance change;

FIG. 11 is a screen shot of a webpage enabling the platform to provide the input for a user to support and adopt the stance based on the recommendation engine in accordance with the invention;

FIG. 12 is a screen shot of a webpage enabling the platform to change a leader association with a user as a function of a user profile and stances; and

FIGS. 13A and 13B are flowcharts for allocating influence values for stances taken on issues in accordance with the invention; and

FIG. 14 is a screen shot of a webpage enabling users to view the impact of their direct and indirect supporters on a user they have formed a support with.

### DETAILED DESCRIPTION OF THE PREFERRED EMBODIMENT

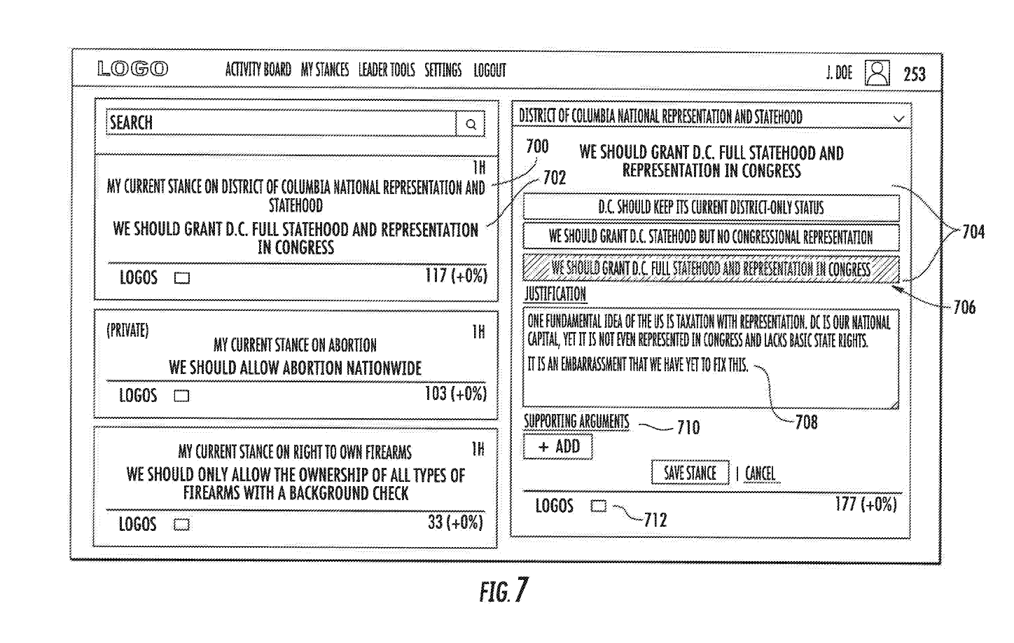

Reference is first made to FIG. 5 in which a flow chart for creating the database for use in accordance with the invention is provided. A list of predefined political issues is stored either at a dedicated server or, in a cloud computing structure, as known in the art, as data; considered as a singular data base. Allowable stances for issues are stored in the database in a step 508. Each political issue is associated with one or more predefined stances in a step 510, with respect to issues stored in the data base as allowable stances defined in a step 508. In a preferred non-limiting embodiment, an input by a system user is received by the database as an input at a website as a stance 602 relative to a stance 600 (see FIG. 6). By way of non-limiting example, if a political issue were statehood for the District of Columbia, the predefined stance could allow full statehood to the District of Columbia as a stance 602, or refuse full statehood to the District of Columbia as an alternative stance. A third stance may be to grant full statehood but not full representation in Congress; and a fourth stance may be representation in Congress of some sort, but not full statehood. It should be noted that while these example stances and justifications are shown as text at a website, either may also be in the form of a video, and audio file, pictures or the like.

With reference back to FIG. 5, a user 500 has the ability to create an issue in a step 510 by storing the details of an issue and a stance (step 508) along with the information associated with that issue as part of a user agenda in the database in a step 502. An agenda is a combination of stance and justification. Such associated information may be the details of the stances, the political issue itself, the justification of the issue, political influence points (weighted numerical values for the issue by supporter), and a person they support, i.e. to which they are linked across a distributed network, based upon the commonality of their stance on an issue as determined by the platform. These are all associated with a single political issue which was created in step 510 and presented as a stance 600.

As will be described below, each user may attract support for their issue stance and/or support an issue stance of another as a first, second, third or beyond supporter within a hierarchy. The influence points of a leader are calculated by a leader's number of first, second, or third, etc. degree supporters. First degree supporters add a larger percent share of their influence than third degree supporters for example.

As seen in FIG. 14, the platform breaks the user supporters attributed to a leader into two categories; direct supporters 1400 or first degree supporters and indirect supporters 1402 or second degree supporters and beyond. These two groups have significantly different levels of impact on a per user basis on the leader's political influence. This is because there is a greater chance of a third degree supporter breaking their support with a leader than a first degree supporter since there is an extra user layer in between (or middleman) deciding whether they would like to accept or reject a stance change. Therefore a leader's ability to influence that third degree supporter's stance is less than that of a first degree supporter. As a result, as can be seen Sarah D has 3000 total supporters, but only has an influence value 1218 of 2300 because she does not receive the full value of each individual supporter for the reasons discussed above. However her impact value 1220 of 2300 has gone up 14%.

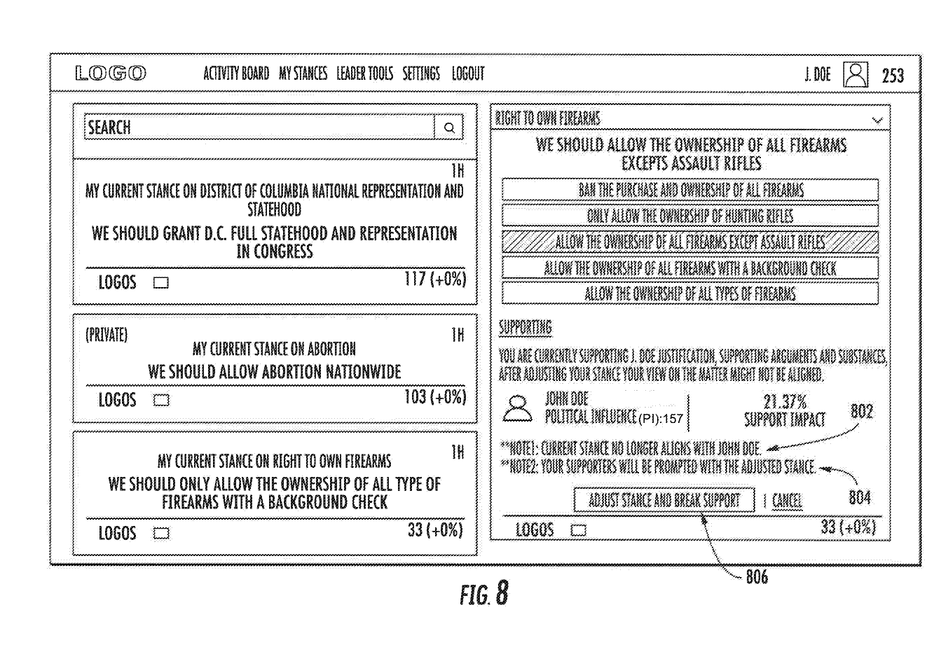

Users link to each other across a distributed network as a function of similar stances on issues. These links are then stored and acted upon by the platform. The platform determines that only a single stance is allowed for each political issue for each user registered with the system. This stance enables the user to take a stance in a step 506. As seen in FIG. 7, the platform provides each of the stances 700 at a website page for selection by a user. The user's chosen stance 702 (see FIG. 7) is taken from the list of allowable stances which becomes the data stored in the database in step 508. The user may also add a written statement, a justification 708, in a step 504, as part of the chosen stance 702 on the political issue stored or put forth in a step 510 which is also contained within the political stance prompt 600 as seen in FIG. 6 and prompt 704 seen in FIG. 7.

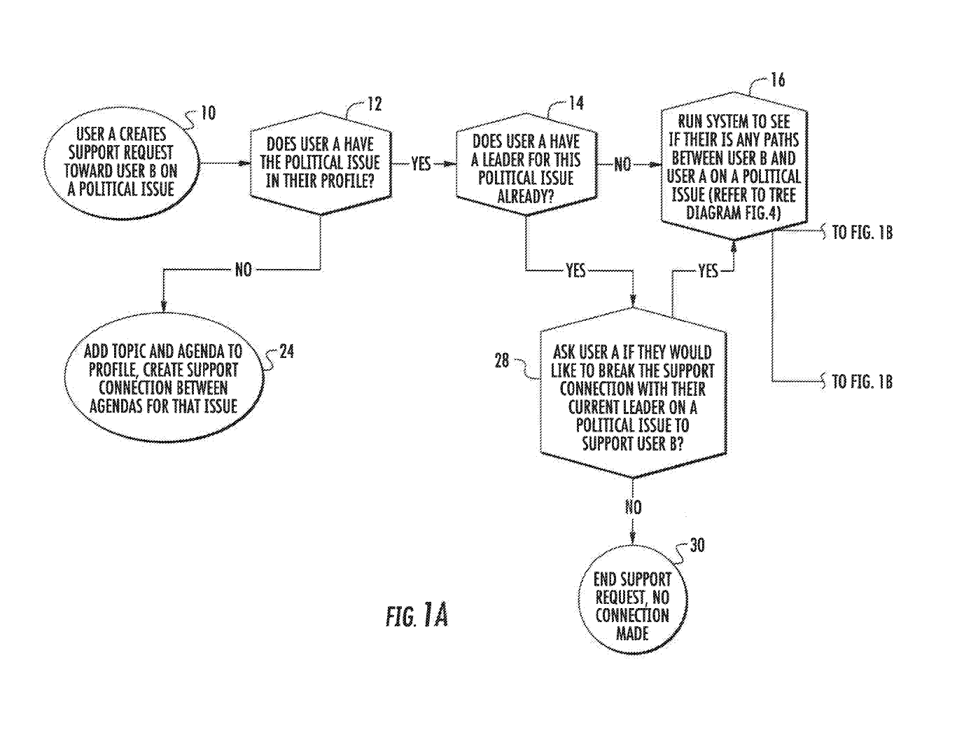

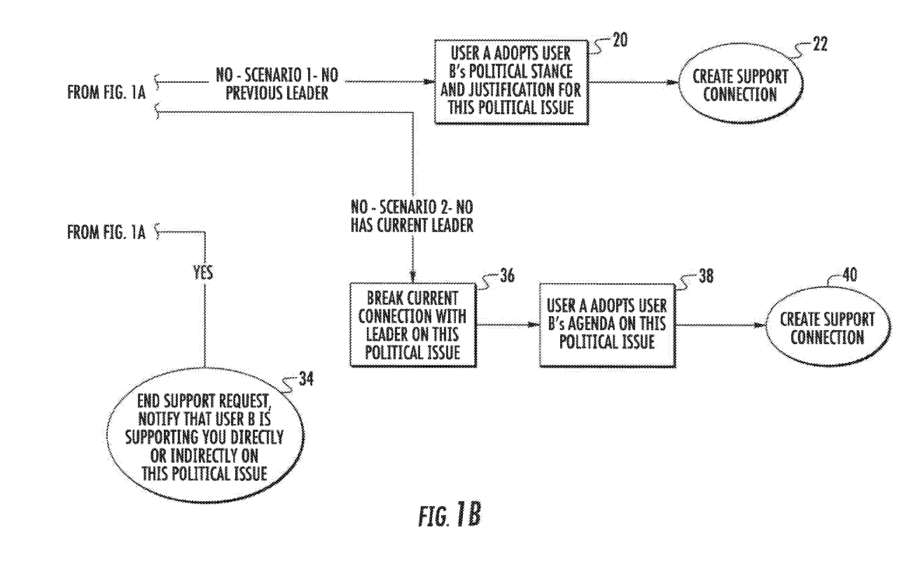

The platform then creates connections between two respective individual users as a function of chosen stances. As a function of the input from the user, a server creates a request to support from a user's political stance, as previously created in step 506, in a step 10 of FIG. 1A. The server, in a step 12, determines whether the user has previously added a stance for this particular political issue to their profile as stored in the database. If the server determines that no such stance has been added, then the issue and stance are added to the profile of the user and a support connection is created between other users having the same political stance for that issue in a step 24.

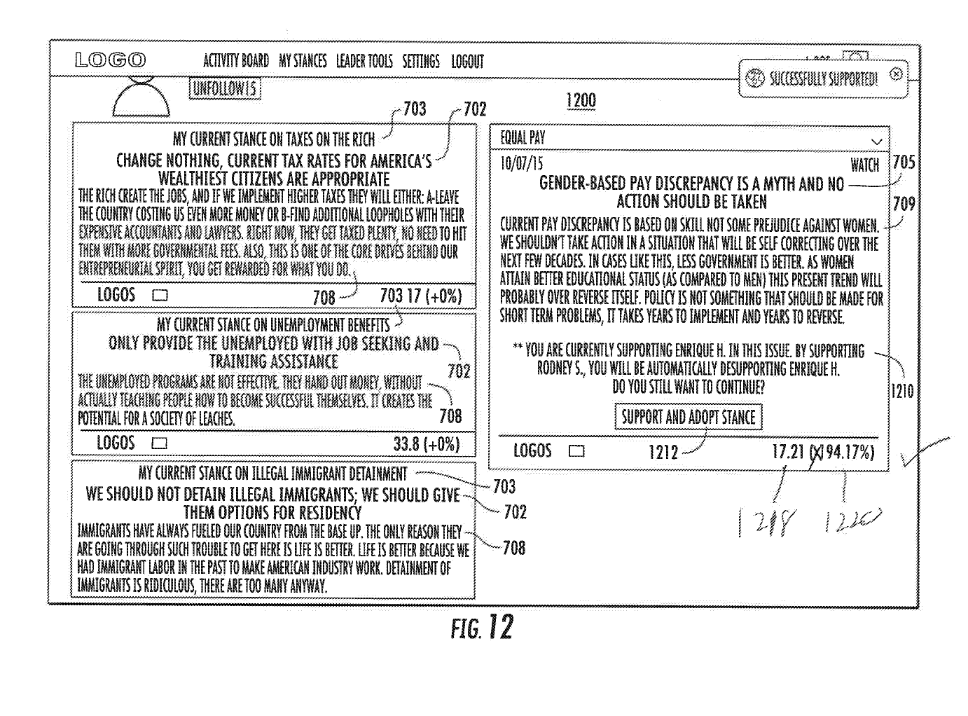

FIG. 12 is a representative website 1200 for an individual user having one or more distinct issues 703 for which that user associated with that website 1200 has taken a stance. At the webpage 1200, the issues 703 are taxes on the rich, unemployment benefits, and illegal immigrant detainment. Each issue 703 has an associated stance 702. By way of example, for the issue taxes on the rich 703, the current stance 702 is change nothing, current tax rates for America's wealthiest citizens are appropriate. Each stance 702 may also have a justification 708 which provides a reasoning for the stance. A proposed newly adopted stance 705 with a proposed justification 709 are also provided at website 1200

If it is determined that the political issue preexists in the profile making the support request, then in a step 14, the server determines whether an existing support connection relating to this political issue exists for that user. If it is determined that a support connection for the user exists already, then in a step 28, the user is prompted by the system at webpage 1200 to provide an input to support and adopt a stance of this new leader breaking support with an existing leader relative to the user. The server enables a user to only support a single proposer of a stance at a single time.

An alert is provided to the user at webpage 1200 that by changing the support connection, they are changing their stances from a current leader to a new leader on a political issue. A prompt 1210 regarding a change of support is provided at website 1200. A graphical user interface support button 1212 enables a change in stance 705 in response to alert 1210. Selection of this interface 1212 changes the support from one leader to another. If the user does not wish to change the support for a particular leader on the issue, the support request ends in a step 30 and no connection is formed. If the user approves the change of support from a first leader to a second leader, then in a step 16, the server determines whether the user is supporting themselves to prevent a looped connected chain.

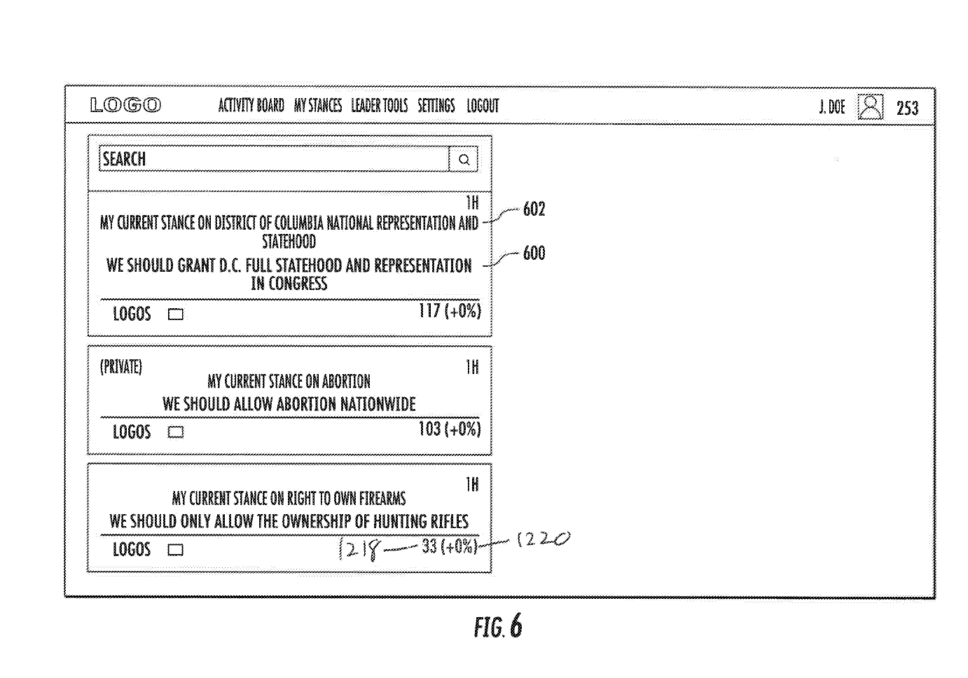

To prevent creating false support, or overly weighted support, for an individual leader, the system will not allow a user to support themselves. Reference is now made to FIG. 4 wherein a flow chart showing the process for the system determining that a user is not supporting themselves is provided. The support request is received in a step 400. In step 404 the server determines whether the leader about to receive support has a leader. If it is determined in step 404 that the selected leader about to receive the support does not have a leader themselves then the support request is accepted in step 402 and the process is returned to enable switching of the connection from the pre-existing leader to the newly requested leader as set forth in the method shown in FIGS. 1A,1B.

In step 404 if it is determined that the to be selected leader has a leader, in a step 406 the server determines whether the leader is the user requesting to support the potentially new leading user. If the server determines that the leader is the user sending the support request, then the process ends and the switch of support is terminated as the user is attempting to support themselves in a step 410. This prevents a leader from creating false, or overwhelming, support for their stances. If the leader being selected is not the user themselves as determined in step 406, then it is again determined in a step 408 whether the leader has a leader for the political issue. If the leader has a leader, the process for step 406 is restarted. If the leader does not have a leader as determined in step 408 then the process ends at step 402 and the support request passes the process back to step 16 of FIG. 1A.

The process returns to step 16 as the determination has now been made utilizing the process of FIG. 4, in step 16, to confirm that the user wishes to break their association and support with one leader on a stance in exchange for a second leader on a stance. If it is determined in process 16 that there are paths between the requesting user and the new leader, then the support request is ended, and the user which is being attempted to be selected is notified that you support them either directly or indirectly on this political issue in a step 34.

If in step 16, there are no previous paths between the user making the request and the requested new leader, then in a step 20, the user adopts the political stance of the newly selected user (second user) and the justification for the political issue and a support connection between the first user and the second user, now the leader, is created in a step 22. This is if there was no previous leader for the stance on the issue.

If there is a leader for that stance, then step 36, the current connection with the leader on this political issue is broken and in a step 38, the user adopts the agenda, i.e. the justification and stance for an issue for the newly selected or requested user (leader) in a step 38, and a support connection is created in a step 40. This is the scenario in which the user when prompted with the alert 12110 at website 1200 in FIG. 12, the system receives an input of the break in the stance.

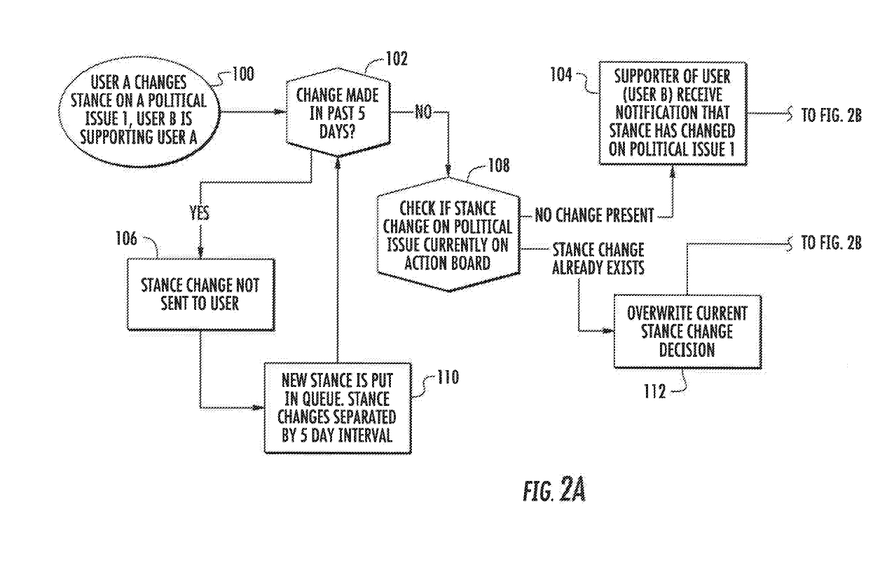

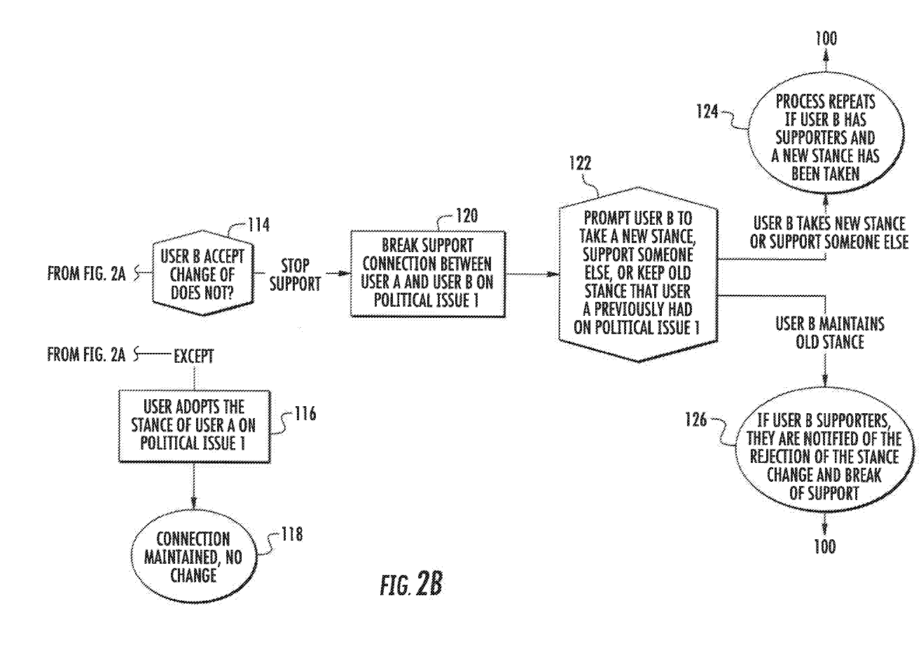

Reference is now made to FIGS. 2A, 2B in which the server enables and carries through the effects for changing the stance for a user (leader) having supporters. Once a support connection is formed, the system monitors the maintenance of that connection as a function of changing decisions by either one of the first and second users; i.e. leader or the supporter.

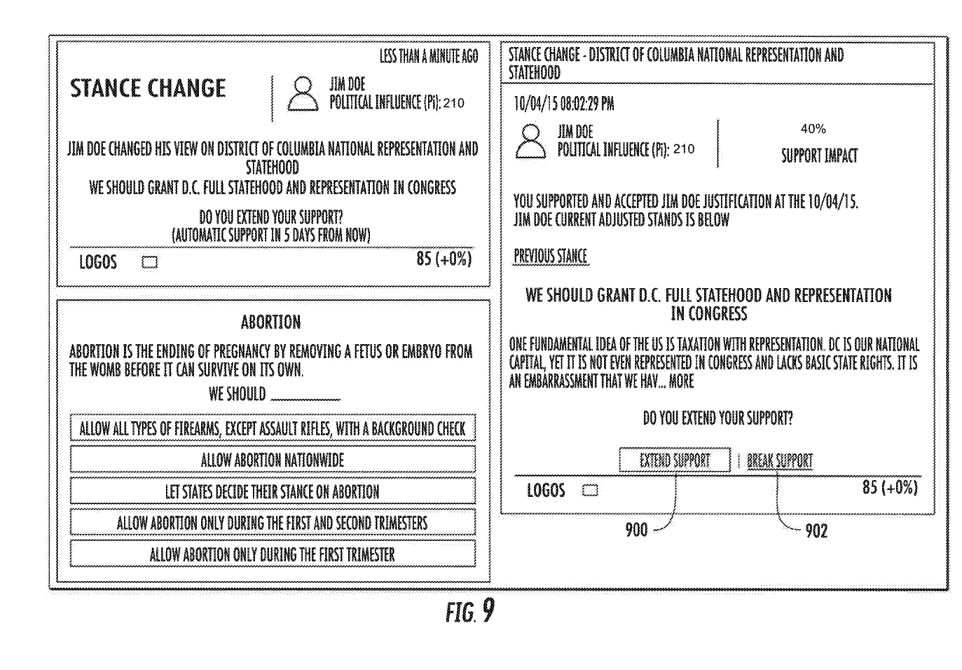

These changes may be triggered by a change of stance or justification by the leader. In a step 100, as seen as a screen shot shown in FIG. 8, a leader (Tim Robbins in this example) being supported by a second user may change their support in response to an alert 802 of FIG. 8, that the leader has changed their stance. The server notifies a supporter at a webpage by providing the notice 802 that a leader associated with that supporter has changed their stance.

The server determines whether the change has been made within a predetermined time period, such as the past five days by way of non-limiting example, in a step 102. Limiting the decision in time, prevents alterations in a stance from occurring too rapidly for supporters to make informed decisions regarding their support as the system enables the users to approve or disapprove each update. If it is determined in step 102 that the change was made in the predetermined time period, then the system in a step 106 does not send a stance change notification to the supporter user. The new stance is placed in a database queue. The stance is to be released after the predetermined time period in a step 110.

The change in stance by the leader will be sent to supporters in the minimum of the desired time interval; five days in a nonlimiting example. If the server releases the stance change from the queue, as determined in step 102 the server determines whether a stance changed on an issue is currently on the action board in step 108. If the change is received in step 102 then the server, in step 108 determines whether the stance has continued to change during that time interval, i.e. has not been returned to the original stance. If the stance change is maintained and already exists, then the old stance, including a previous stance change decision is overwritten in a step 112 and is stored in the database.

If a stance change already exists, then the stance change decision is overwritten in step 112. If no change is present, the stance change is posted in step 104.

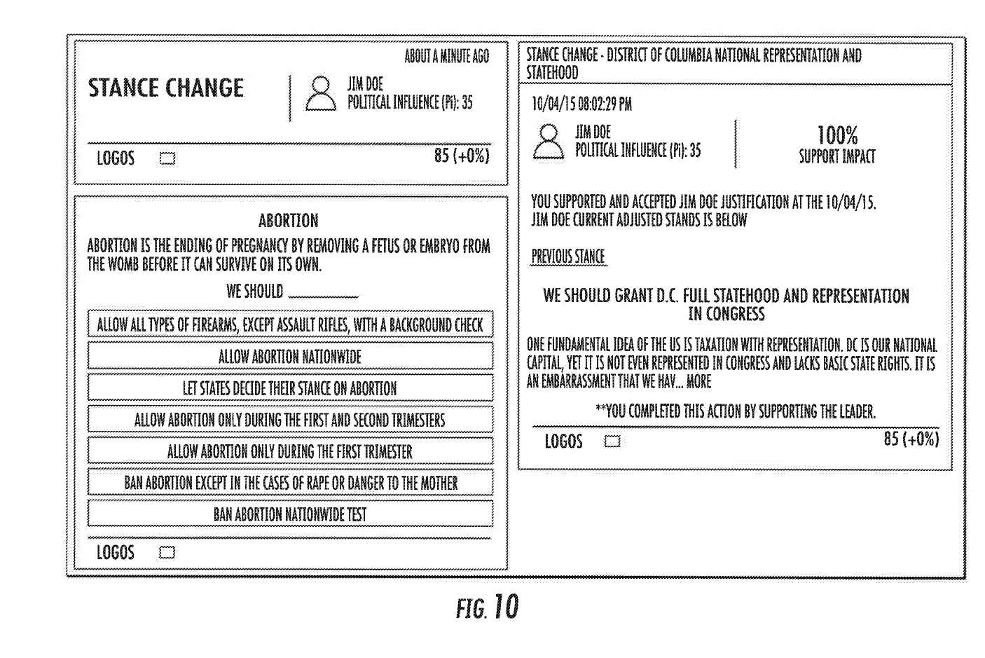

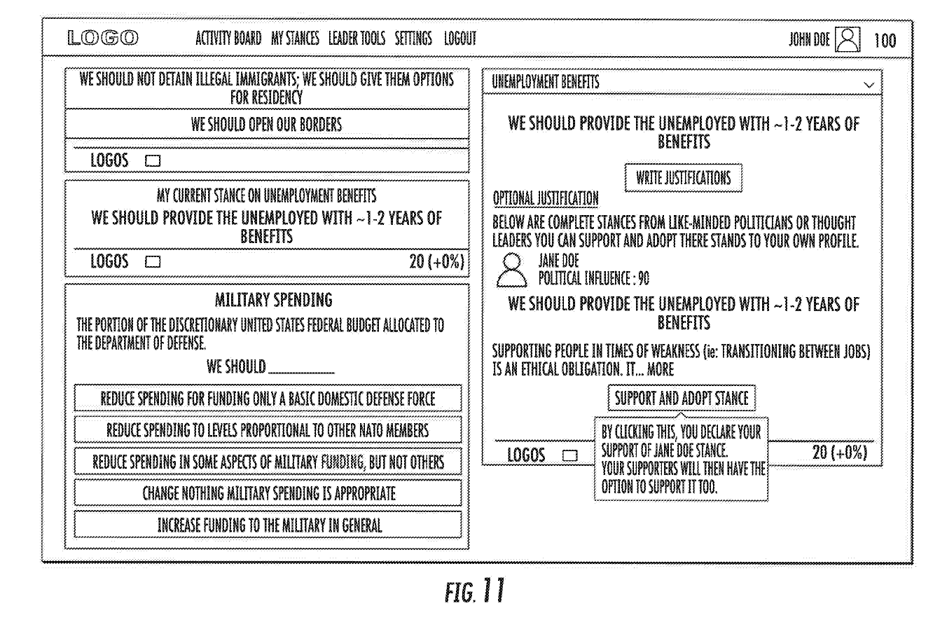

The server notifies the supporting user with a prompt 906 (FIG. 9) at a webpage 904 for the user offering the user the options to accept the stance change or not in a step 114. If the input adoption of the new justification at a graphical user interface (GUI) input 900 by extending their support in a step 116, the connection is maintained in step 118. If the user (supporter) inputs a break of support in step 120 by utilizing GUI input 902 at webpage 904 of FIG. 9, the supporting user may be prompted to take a new stance, support someone else, or keep the old stance that the leader previously had in a step 122. If the supporting user decides to take a new stance or to support somebody else, the supporters of that user will be notified, in a step 124, that a new stance has been taken returning the process to step 100 for all downstream supporters as indicated at alert 804. If the supporting user decides to maintain the old stance and the supporting user has supporters, the supporters are notified of the rejection of the stance change and break of support in a step 126 and again the process is returned to step 100 for the downstream supporters of the user.

It should be noted that the above example was given in terms of stance. However, it is readily understood that the support changes and alerts can be made as a function of changes in justification as well. This can he true where there is no change in stance.

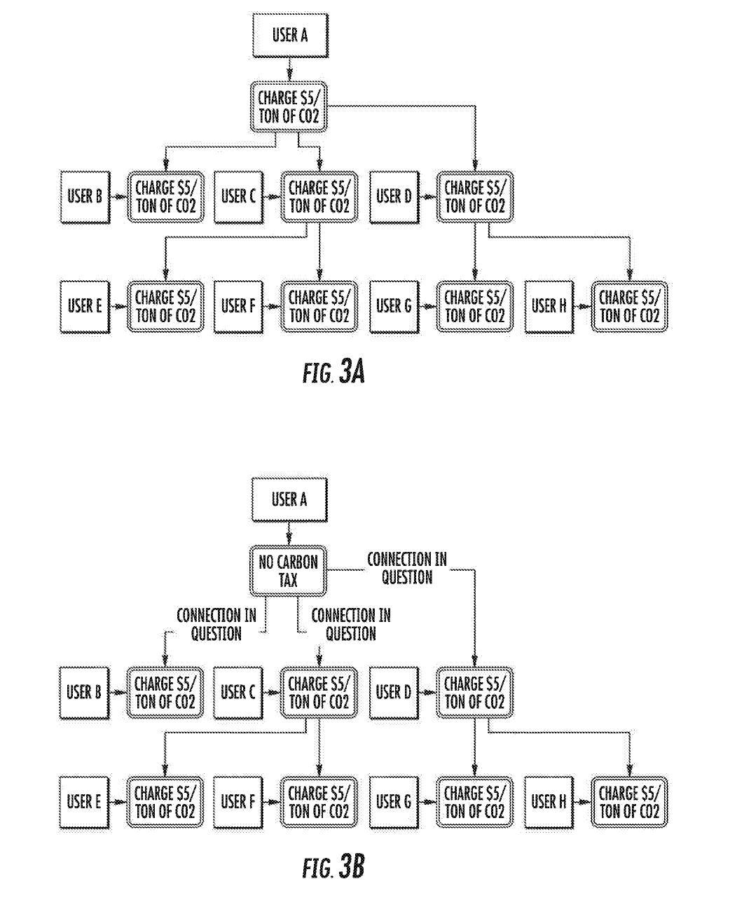

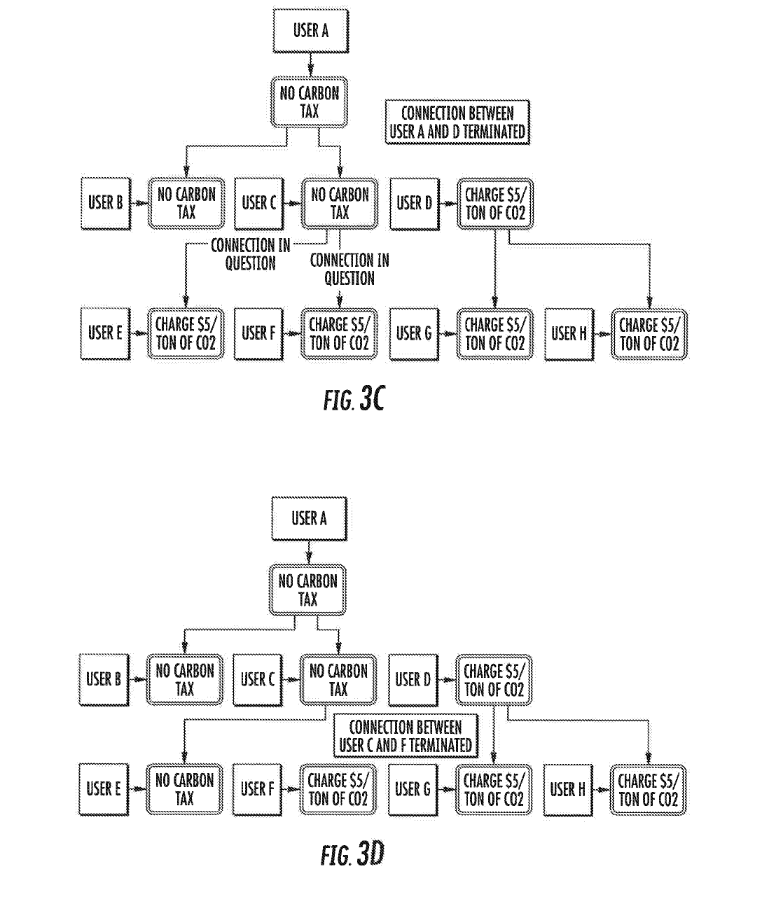

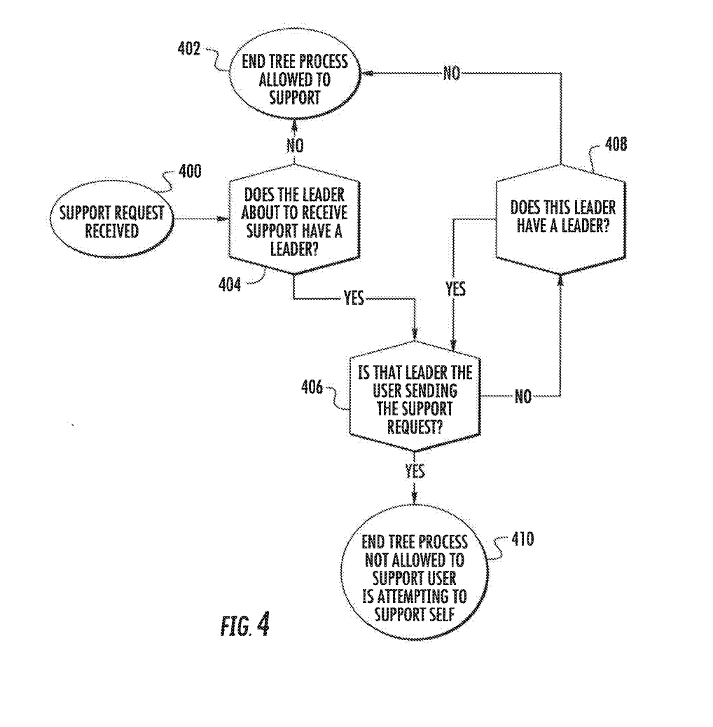

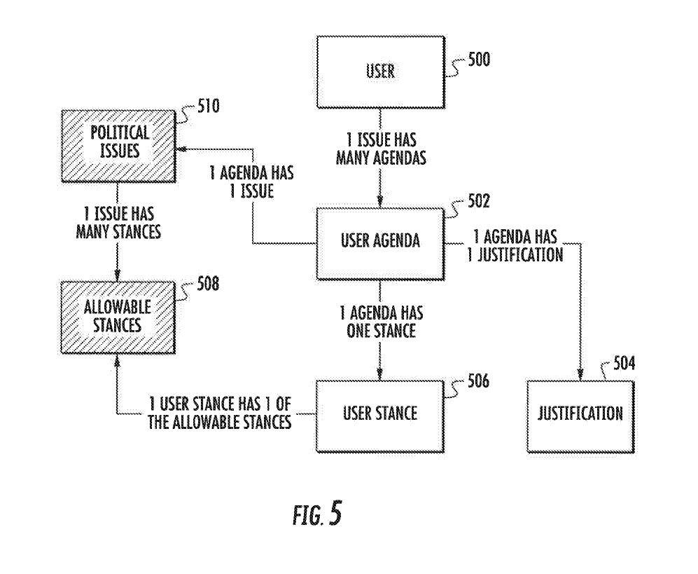

Reference is now made to FIGS. 3A-3D. These figures illustrate connections between users within the network on a specific issue, that of a carbon tax and the various stances. For simplicity of illustration, the stances are no carbon tax and a charge of $5 per ton. As can be seen, between FIGS. 3B and 3C, user A, the relative leader in this illustration, has changed their stance on the issue to supporting no carbon tax. User D did not change their position and therefore is no longer connected to, nor a supporter of User A. User G is a supporter of user D as his user H. Each of these supporters has maintained their stance to be consistent with user D. User D now becomes the leader with two supporters, and is no longer connected to user A. As seen from FIG. 3C to FIG. 3D, user E changed their position to maintain itself as a supporter of user A. On the other hand, user F no longer supports user C and therefore both user C and user A have lost the support of user F.

The support impact is the political influence of an individual supporter to a particular leader, the supporter is currently supporting. The system uses an algorithm to calculate a leader's political influence not just based on the number of supporters they may have, but the political influence of each supporter. More specifically, support impact is a function of the percentage of the leader's influence a respective user's connection counts for. In a non-limiting example, if a leader has 100 influence points on an issue, and a single user is contributing 50 points, then that user's impact is 50 percent.

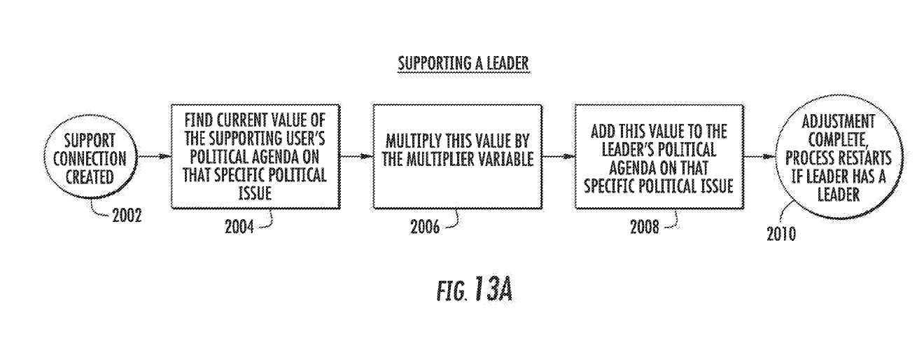

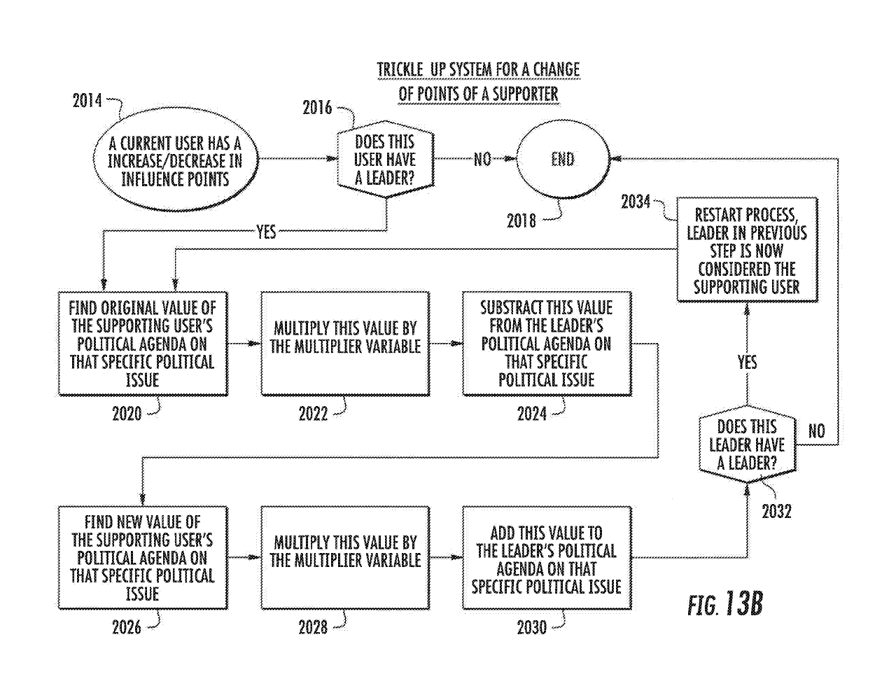

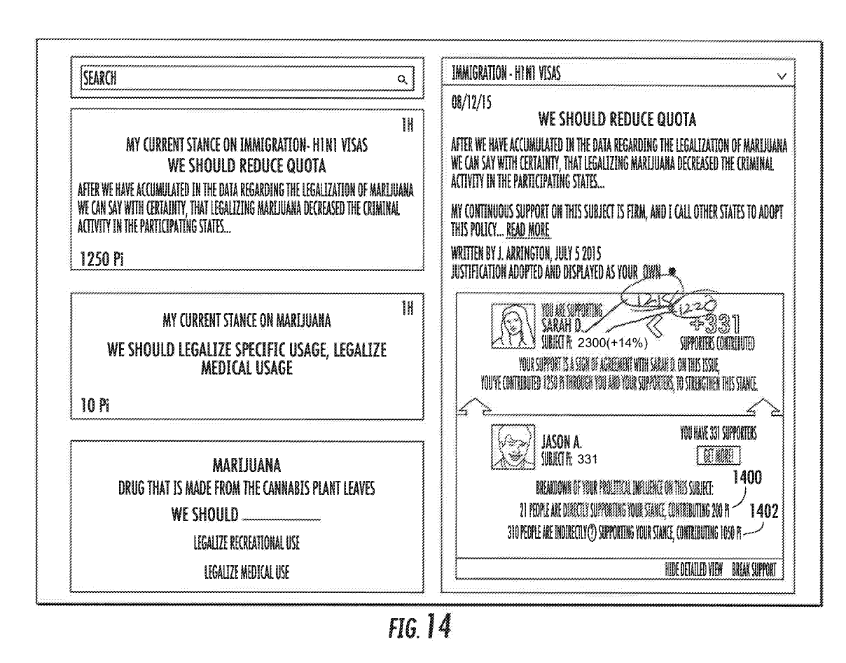

The transmission of influence value 1218 between users occurs on the creation of a support connection described previously. Flow influence value 1218 is transmitted is described in FIGS. 13A, 13B. When a first user supports another user a connection is made in a step 2002, on a specific political issue. The current influence value 1218 for that first user creating the support connection on that specific issue is pulled from the database in a step 2004. Influence value 1218 is then multiplied by the multiplication variable in a step 2006, which, in one non-limiting example, is a system wide default value. However it does not have to be system wide and can be calculated as a function of various factors such as a leader's historical loyalty of its supporters, user activity, length of support for an issue, off-line support activities, etc. The resulting value is added to the leader's influence value for that specific issue, in a step 2008. The adjustment is then finished, in a step 2010. If the leader in the last scenario has a leader on this political issue, the process restarts for the upstream leader to provide the upstream leader the full weight of the support on the stance as the influence value of each individual supporter.

The process for removing a support connection is the same, except the value at step 2008 is not an addition but a subtraction.

In another non-limiting embodiment, the default multiplier variable is set to 70% due to lack of historical data. The algorithm may however take into account the individual historical loyalty of the user and the average turnover of a leader's supporters during a stance change.

A “Trickle Up” adjustment system shown in FIG. 13B details the update process when there is a change of influence points for a current supporter occurs in a step 2014 and is a function of the addition of a new supporter or loss of a supporter. In this case the current supporter has an increase or decrease in influence points for a particular issue. A check is run if this user has a leader, in a step 2016. If the user has no leader and is the de facto leader, the process stops in a step 2018.

If the user does have a leader, the original influence value for that user and that particular political agenda for the political issue is found in a step 2020. This influence value 1218 is then multiplied by a multiplier variable in a step 2022. This resulting value is subtracted from the leader's political agenda for that political issue in a step 2024. This brings the leader's influence value down to a level as if that user had never formed a support connection with the leader.

In the situation where an intermediate supporter has lost supporters, the influence of the supporters readjusted by subtracting out the supporter value from the leader overall support as discussed above. Then the new value of the supporting user for that particular political agenda for the political issue is found in a step 2026. This is then multiplied by the multiplier variable, 2028. Then this value is added to the leader's political agenda for that political issue in a step 2030. The process then checks if the leader that has just received the influence points update has a leader in a step 2032. If they do the process is restarted and the previous “leader” is now the supporter passing up the effect of the influence change in a step 2034. If they do not have a leader the process ends.

This is significant because if a leader has many people supporting them on an issue, who a user chooses to support (if anybody) becomes important since that user will be sharing some of their points with the leader. The larger a single user's impact, the more sway that user may have when a leader is considering new stances or policy decisions.

The above description has been given in the environment of political stances and issues. However the system may also operate on aligned likes and dislikes such as agreeing on restaurants, movies, or the like to provide support for chefs, restaurateurs, and movie critics or producers. It can also work in other voting systems such as aligning votes of common stock among certain shareholder factions to support certain changes in the governance of corporations, or the system may be used to align people among other viewpoints outside politics such as religion and philosophy.

What is claimed is:

1. A method for determining support for a stance on an issue comprising the steps of:
a first user asserting a stance on an issue, storing the stance and an association between the stance and the first user to be accessible across a distributed network;
at least one of a second user and the third user asserting the stance;
creating a link between the first user and at least one of the second user and third user, as a function of asserting the stance, as a supporter of the first user; and
storing the link between the first user and at least one of the second user and third user to be accessible across the distributed network.

2. The method of claim 1 further comprising the step of dissolving the respective link between the first user and at least one of the second user and third user as function of a change in the respective stance of at least one of the second user and third user where the stance on the issue is no longer shared between the first user and at least one of the second user and third.

3. The method of claim 1, further comprising the step of:
determining a leader for a stance on the issue, determining one or more supporters for that issue and linking each supporter to the leader as a function of the stance for the issue.

4. The method of claim 1, wherein the first user changes the stance on the issue, and each of the at least second user and third user receives a prompt across the distributed network regarding the change.

5. The method of claim 4 wherein the prompt is not sent across the distributed network for a predetermined time period following the change in stance.

6. The method of claim 4, wherein the prompt includes an ability to maintain the current stance by the second user and third user and change the stance to the current stance of the first user by the second user and third user.

7. The method of claim 6, wherein at least one of the second user and third user changes this stance associated with the at least one of the second user and third user, and storing the stance to be accessible across the distributed network.

8. The method of claim 6, wherein at least one of the second user and third user maintains the current stance associated with the at least one of the second user and third user, and the link between the first user and the at least one of the second user and third user maintaining the current stance is changed.

9. The method of claim 8, wherein the link is changed from the first user to a fourth user as a function of a stance associated with the fourth user and the current stance associated with the at least one of the second user and third user maintaining the stance, and storing the link between the fourth user and the at least one of the second user and third user to be accessible across a distributed network.

10. The method of claim 9, further comprising the step of determining whether the fourth user is either one of the second user and third user, and not creating the link between the fourth user and the at least one of the second user and third user, if it is determined that the fourth user is either one of the second user and third user.

11. The method of claim 1, further comprising the steps of:
the first user asserting a justification for the stance, storing the justification and an association between the justification and the first user to be accessible across a distributed network;
at least one of a second user and the third user having the justification for the stance;
the link between the first user and at least one of the second user and third user, also being function of asserting the justification.

12. The method of claim 11, further comprising the step of dissolving the respective link between the first user and at least one of the second user and third user as function of a change in the respective justification of at least one of the second user and third user where the justification on the stance is no longer shared between the first user and at east one of the second user and third.

13. The method of claim 1, further comprising the step of determining an influence value for each of the first user, second user and third user; the influence value of the first user including at least a portion of the influence value of the second user when there is a link between the first user and the second user, and the influence value of the first user including at least a portion of the influence value of the third user when there is a link between the first user and the third user.

14. The method of claim 13, wherein the portion of the influence value is a function of at least one of historical loyalty to the first user, the activity of the at least second user and third user, the length of support for an issue by the second user and third user.
